(19) United States
(12) Patent Application Publication
(10) Pub. No.: US 2019/0213118 A1
(43) Pub. Date: Jul. 11, 2019

(54) METHOD AND DEVICE FOR PROCESSING BINARY CODE DATA

(71) Applicant: Robert Bosch GmbH, Stuttgart (DE)

(72) Inventors: Jens Gladigau, Renningen (DE); Bernd Mueller, Leonberg (DE); Sebastian Bolk, Warmbronn (DE)

(21) Appl. No.: 16/311,914

(22) PCT Filed: May 31, 2017
(86) PCT No.: PCT/EP2017/063107

§ 371 Date: Dec. 20, 2018

(30) Foreign Application Priority Data
Jun. 22, 2016 (DE) 10 2016 211 124.8

(51) Int. Cl. G06F 11/36; G06F 8/53; G06F 9/445

(52) U.S. Cl. CPC G06F 11/3692; G06F 9/44589; G06F 8/53

(57) ABSTRACT

A method is described for processing binary code data (BCD) containing at least one machine program (MP1), characterized by the following steps: forming (10) test data (PD) as a function of at least one portion of the binary code data (BCD), in particular, as a function of a portion of the binary code data that contains the machine program (MP1) or a portion of the machine program (MP1), the test data (PD), in particular, enabling changes of the at least one portion of the binary code data (BCD) to be recognized; inserting (20) at least one portion of the test data (PD) into the binary code data (BCD), as a result of which supplemented binary code data (BCD′; BCD″) are obtained.

### FIELD OF THE INVENTION

The present invention relates to a method for processing binary code data containing at least one machine program. The present invention further relates to a device for carrying out such a method.

The present invention further relates to a method for processing binary code data containing at least one machine program and a corresponding device.

### BACKGROUND INFORMATION

In embedded systems and other computer systems, it is desirable to be able to recognize a change of a binary code, which is executed by a processing unit of the relevant system from a memory, in order to avoid the processing of invalid data. Such a change recognition of binary code is important, in particular, in safety-relevant applications such as, for example, in control units for internal combustion engines or braking systems of motor vehicles. It is already known to design working memory (RAM, random access memory) modules, in particular, external memory modules, in such a way that they recognize a change of binary code stored in them. Examples of these are RAM modules with ECC (error correcting code) protection. For various reasons, however, (for example, costs, power consumption, memory bandwidth) such ECC RAM modules are not usable in all fields of application.

In addition, it is known to use software-based approaches for recognizing a change of binary code. However, these methods are slow in execution and costly to implement.

### SUMMARY OF THE INVENTION

According to the present invention, a method is provided for processing binary code containing at least one machine program, which is characterized by the following steps: forming test data as a function of at least one portion of the binary code data, in particular, as a function of a portion of binary code data that contains the machine program or a portion of the machine program, the test data, in particular, enabling changes to the at least one portion of the binary code data to be recognized; inserting at least one portion of the test data into the binary code data, as a result of which supplemented binary code data are obtained.

This enables a processing unit that evaluates or processes the binary code data or the supplemented binary code data to carry out an evaluation of the test data and to therefore infer a change of the binary code data secured by the test data. In other words, an undesirable change of the binary code data may be inferred by evaluating the test data embedded according to the present invention in the binary code data, as a result of which, for example, an efficient error recognition of binary code data is implementable.

The test data are particularly preferably formed as a function of at least one portion of a machine program contained in the binary code data, so that a change of the machine program is determinable using the principle according to the present invention. Alternatively or in addition, the test data may also be formed as a function of other contents of the binary code data such as, for example, payload data or constant data, which contain, in particular, no executable machine instructions, as a result of which the payload data or constant data, optionally in addition to machine programs, may also be secured following the principle according to the present invention.

In one preferred specific embodiment, all test data that were formed according to the present invention are inserted into the binary code data, as a result of which the checking of the binary code data or of the supplemented binary code data according to the present invention may be carried out only when the supplemented binary code data are present. In other specific embodiments, however, it is also conceivable to reserve at least a first portion of the test data formed according to the present invention at another memory location than embedded in the binary code data, whereas a second portion of the test data formed according to the present invention as already described above is inserted or embedded in the binary code data. In this case, recourse to both the first portion of the test data as well as to the second portion of the test data may be necessary for assessing the fact whether a change of the binary code data exists, which is taken into consideration in a corresponding implementation of a test method.

In one particularly preferred specific embodiment, the formation of the test data includes a formation of at least one test value, in particular, of at least one test sum for a cyclical redundancy check (CRC). In this case, redundant information may be inserted as test data in addition to the binary code data to be secured in a manner known per se. Alternatively or in addition, at least one hash value may be formed as a function of the at least one portion of the binary code data. It is conceivable, for example, to provide a hash value formation according to the secure hash algorithm (SHA), as it is defined in the Secure Hash Standard (SHS), publication number FITS 180-4, edition August 2015 and retrievable from the Internet, for example, at http://csrc.nist/gov/publications/fips/fips_180-4/fips-180-4.pdf.

Other comparable methods are also conceivable for forming the test data.

In another advantageous specific embodiment, it is provided that the binary code data are divided into blocks of equal or of different size, at least one of the blocks obtained in this way being assigned test data. A corresponding block size is particularly preferably adapted to the size of a cache line of a memory system of the processing unit processing the binary code data. This enables a particularly efficient access to the individual blocks and to the assigned test data. The block size may amount to 512 bits, for example. Values differing therefrom are alternatively also possible.

In another advantageous specific embodiment, it is provided that memory addresses, in particular, vector addresses or jump targets, of the supplemented binary code data are adapted, in particular, in order to take the test data inserted into the binary code data into account. In this way, it is advantageously enabled to ensure an undisrupted execution of machine programs contained in the binary code data, in spite of the test data embedded according to the present invention in the binary code data.

A device for processing binary code data containing at least one machine program is specified as another approach to achieving the objective of the present invention.

Yet another approach to achieving the objective of the present invention is specified by a method for processing binary code data containing at least one machine program, the method including the following steps: evaluating test data contained at least partially in the binary code data, which were formed as a function of at least one portion of the binary code data at a first point in time, the evaluation of the test data involving, in particular, the determination of whether the at least one portion of the binary code data at the point in time of the evaluation is changed relative to the first point in time, processing at least one portion of the binary code data as a function of the evaluation.

In one particularly preferred variant of the processing method according to the present invention, the test data contained or embedded in the binary code data were obtained by the above described method for processing binary code data.

As already described above, the test data in one specific embodiment may be fully embedded in the binary code data or may be contained in the supplemented binary code data. In this case, the test data may accordingly be removed from the binary code data and provided for evaluation. In other specific embodiments, in which the test data are at least partially also reserved outside the (supplemented) binary code data, the different portions of the test data are to be provided, if necessary, from the different memory locations (examined binary code data, other memory locations), before these test data are evaluated.

The evaluation of the test data may, for example, be carried out by verifying a test value or a test sum for a cyclic redundancy check if a CRC method was used for forming the test data. If one or multiple hash values were used to form the test data, other evaluation algorithms may accordingly be used in the evaluation of the test data according to the present invention. In this case, for example, an evaluation of the test data may provide a renewed hash value formation via the portions of the binary code data protected by the test data and a subsequent comparison of this in conjunction with the evaluation of newly obtained hash values with the hash value obtained in the test data. If both hash values coincide, the integrity of the parts of the binary code data protected by the test data may be inferred.

In one preferred specific embodiment, it is provided that prior to the step of evaluating, it is first ascertained whether the binary code data contain test data. In this way, the reliability of the method is further enhanced and, in particular, may be controlled by the fact that an evaluation takes place only if test data are actually present. Alternatively, an evaluation of potentially present test data may also be made a function of an operating state of a unit processing the binary code data. It is conceivable, for example, that test data present per se are not always evaluated, but evaluated only sporadically and/or periodically in greater time intervals.

In another advantageous specific embodiment, it is provided that an error response is initiated if the evaluation indicates that the at least one portion of the binary code data at the point in time of the evaluation is changed relative to the first point in time. According to one specific embodiment, an error response in the form of an interrupt request (IRQ) may be sent to a processing unit, which is intended to process the binary code data or execute the machine programs contained therein. Alternatively or in addition to the interrupt request, an entry in an error memory (non-volatile memory or also a register of a processing unit or the like) may take place.

The use of a dedicated logic within a processing unit for the central handling of errors is also conceivable in one specific embodiment; a change of binary code data is then signaled to this central error handling logic. One possible response of the error handling logic is the signaling of an error via a so-called error pin to the system that integrates the processing unit.

In another advantageous specific embodiment, it is provided that test data contained in the binary code are replaced by machine instructions executable by the processing unit prior to an execution of the at least one machine program. In this way, it is advantageously ensured that the processing unit is not inadvertently provided with the test data as executable data, which could provoke undesirable responses of the processing unit. In this case, the machine instructions are particularly preferably selected in such a way that they include one or multiple zero operations (for example, NOP “no operation”). In this way, an area of the binary code data used initially for storing test data may be easily and efficiently transformed into a machine-executable “program module”.

A further approach to achieving the objective of the present invention is specified by a device for processing binary code data containing at least one machine program. In preferred specific embodiments, the device is further designed for carrying out the aspects of the method described above.

A processing unit, in particular, a microcontroller, a digital signal processor or another processor having at least one processor core for executing machine programs is specified as a further approach to achieving the objective of the present invention, which is characterized in that it is assigned at least one device according to the present invention for processing binary code data, the at least one device being particularly preferably integrated into the processing unit. In one design of the processing unit as a programmable logic module, for example, a FPGA (field programmable gate array), it is also conceivable to implement the functionality of the processing device according to the present invention via a part of the FPGA module.

When applying the principle according to the present invention, it is advantageously possible to provide a control unit for a vehicle, in particular, a motor vehicle, which includes a device according to the present invention for processing binary code data and/or at least one processing unit according to the present invention.

### BRIEF DESCRIPTION OF THE DRAWINGS

FIG. 1a schematically shows binary code data, which contain multiple machine programs.

FIG. 1b schematically shows binary code data according to a first specific embodiment of the present invention.

FIG. 1c schematically shows binary code data according to another specific embodiment of the present invention.

FIG. 2 schematically shows a simplified flow chart of one specific embodiment of the method according to the present invention.

FIG. 3 schematically shows a simplified block diagram of one specific embodiment of a device according to the present invention.

FIG. 4 schematically shows a time diagram according to one specific embodiment of the present invention.

FIG. 5 schematically shows a simplified flow chart of another specific embodiment of the method according to the present invention.

FIG. 6 schematically shows a block diagram of one specific embodiment of a device according to the present invention.

FIG. 7 schematically shows a block diagram of another specific embodiment of a device according to the present invention.

FIG. 8 schematically shows a motor vehicle that includes a control unit according to one specific embodiment of the present invention.

### DETAILED DESCRIPTION

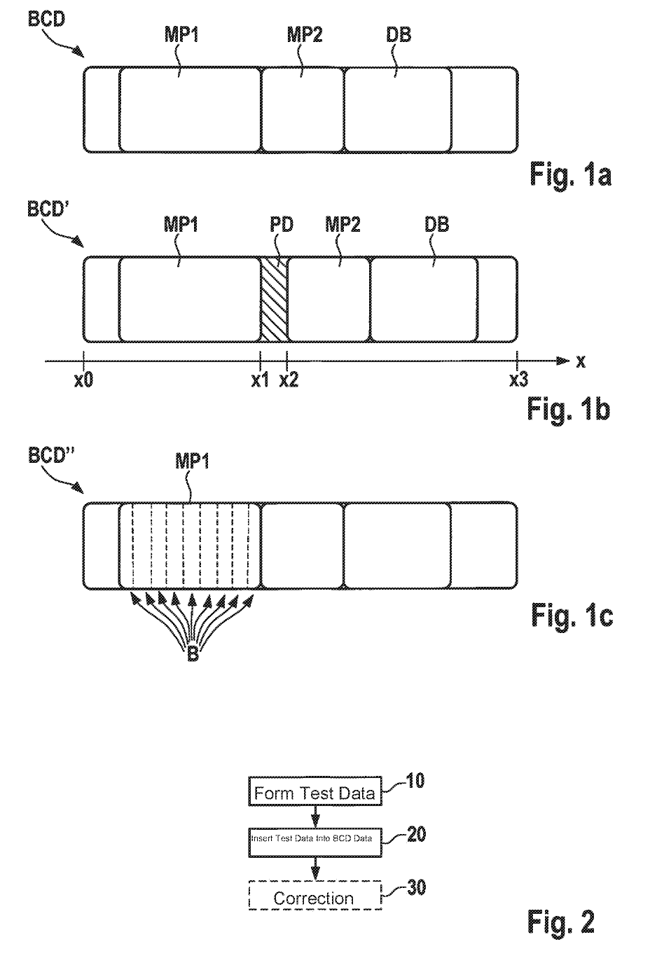

FIG. 1 schematically shows binary code data BCD, as they are obtained or processed by processing units, for example, in embedded systems, in a manner known per se. The binary code data BCD contain, by way of example, a first machine program MP1 and a second machine program MP2, as well as a data area DB, which contains payload data or constant data, which therefore represent no machine programs executable by a processing unit or by a processor core of the processing unit. The binary code data BCD may optionally also contain additional components or data not further depicted here.

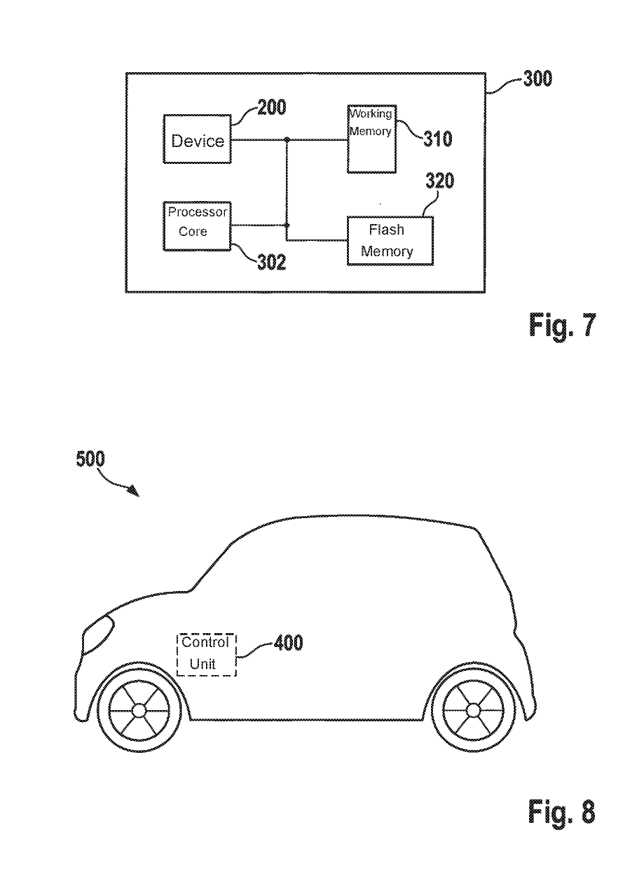

Binary code data BCD depicted in FIG. 1a may be processed, for example, by a processing unit 300 depicted by way of example in FIG. 7, which may involve a microcontroller or the like. For example, machine programs MP1, MP2 (FIG. 1) may be executed, in particular, by a processor core 302 (FIG. 7) of microcontroller 300. Microcontroller 300 further includes a working memory 310, which may, for example, be a DDR (double data rate)—RAM (random access memory) module. The DDR-RAM may optionally also be designed as an external RAM.

Microcontroller 300 also includes a secondary memory 320, which may be a flash memory, for example.

It is assumed in the following, for example, that microcontroller 300 is a part of an embedded system, for example, a component of a control unit 400 (FIG. 8) of a motor vehicle 500, and that during a system start of microcontroller 300 (FIG. 7) or of the control unit, a program code provided for execution is copied from flash memory 320 into working memory 310. Processor core 302 of microcontroller 300 then executes the program code located in working memory 310 from this working memory 310.

In this case, normally invariably whole so-called cache lines (for example, i.e. data blocks having a length of 512 bits) are particularly preferably always copied from working memory 310 into an internal cache (not shown), in particular, an instruction cache, of processor core 302.

Microcontroller 300 also includes a device 200 according to the present invention for processing binary code data, as it is described in greater detail further below with reference to FIGS. 5 and 6.

The program code described above by way of example with reference to FIG. 7, which is copied at a system start from flash memory 320 into working memory 310, may, for example, be binary code data BCD depicted in FIG. 1a and already described above.

According to the present invention, a processing of binary code data BCD is provided so that a generally undesirable change of binary code data, as it may occur, for example, in the case of an error in the area of flash memory 320 (FIG. 7) or also of working memory 310, is recognizable. Such errors may, for example, be so-called “bit kipper”, i.e., the spontaneous changing of the value of a binary memory cell from the value “logic zero” to the value “logic one”, or vice versa.

FIG. 2 shows a simplified flow chart of one specific embodiment of the method according to the present invention. In a first step 10, test data are formed as a function of at least one portion of binary code data BCD (FIG. 1a). The test data advantageously enable a recognition of changes of the at least one portion of binary code data BCD. In step 20, the test data or at least a portion of test data PD are subsequently inserted into binary code data BCD, as a result of which supplemented binary code data BCD′ are obtained. This state is depicted in FIG. 1b. It is apparent from FIG. 1b that supplemented binary code data BCD′ obtained by the method according to the present invention also obtain test data PD with respect to elements MP1, MP2, DB from FIG. 1a. It is further apparent from FIG. 1b that supplemented binary code data BCD′ occupy a memory area along a memory coordinate x from the coordinate value (or memory address) x0 to the coordinate value x3, test data PD in the present case having been inserted into the memory area between coordinates x1, x2, therefore having been embedded between machine programs MP1, MP2 into binary code data BCD according to FIG. 1a.

According to the present invention, test data PD may be advantageously evaluated in a manner described further below, in order to determine changes of the at least one portion of binary code data BCD, as a function of which, test data PD were formed.

In one specific embodiment, for example, it is conceivable that first machine program MP1 contains a safety-relevant function and, accordingly, the reliable execution of machine program MP1 is of particular importance. In this case, test data PD according to the present invention may be formed as a function of first machine program MP1 and, as already described and depicted in FIG. 1b, embedded in binary code data BCD. Test data PD may then be evaluated in a method described later in greater detail, it being determinable by this evaluation whether first machine program MP1 or portions thereof were changed with respect to a point in time at which test data PD were formed as a function of first machine program MP1.

In other specific embodiments, it is conceivable to form additional test data also for second machine program MP2 and/or for data area DB.

In another advantageous specific embodiment, it is provided that binary code data BCD or portions thereof, in the present case shown by way of example for first machine program MP1, are divided into blocks B (FIG. 1c) of equal or of different size, at least one of blocks B obtained in this way being assigned test data in the manner described above. In the present case, for example, first machine program MP1 is divided into a plurality of different sized blocks B in FIG. 1c, individual blocks B being assignable corresponding test data PD. Test data PD for respective blocks B may be integrated into binary code data BCD″, similar to the exemplary embodiment described above with reference to FIG. 1b, which in the present case is not depicted in FIG. 1c for reasons of clarity.

A corresponding block size for blocks B is particularly preferably selected based on the size of a cache line of a memory system of processing unit 300, which processes the binary code data. This enables a particularly efficient access to individual blocks B and to the assigned test data. The block size may amount to 512 bits, for example. Values differing therefrom are alternatively also possible.

In another preferred specific embodiment, it is possible that after step 20 of inserting (FIG. 2) test data PD into binary code data BCD, memory addresses, in particular, vector addresses or jump targets of supplemented binary code data BCD′ (FIG. 1b) and BCD″ (FIG. 1c) are adapted, in particular, in order to take test data PD inserted into binary code data BCD into account. It is conceivable, for example, that one or multiple machine programs contained in binary code data BCD include jump instructions or other branchings, which are specified in conjunction with a compilation process or of a linking process in the form of absolute memory addresses along memory coordinate x (FIG. 1b). In this case, the corresponding address connections for the jump targets are potentially disrupted by the insertion of test data PD according to the present invention, which may, if necessary, be corrected by optional step 30 according to FIG. 2. For example, the vector addresses situated in the address area of second machine program MP2 in supplemented binary code data BCD′ of FIG. 1b may be adapted in such a way that the insertion of test data PD after address x1 is taken into account. Simply put, the jump instructions in machine programs MP1, MP2 of supplemented binary code data BCD′, for example, may be adapted for the jump operation with respect to their target addresses in such a way that the “increase” in the length of supplemented binary code data BCD′ occurring as a result of the insertion of test data PD is compensated for. The relevant target addresses may, for example, be incremented by the value x2-x1. Comparable measures are conceivable for addressing data situated in data area DB of supplemented binary code data BCD′.

In one particular preferred specific embodiment, the formation 10 (FIG. 2) of test data PD (FIG. 1b) includes a formation of at least one test value, in particular, at least one test sum, for a cyclic redundancy check. In this case, information redundant to the binary code data to be secured may be inserted as test data in a manner known per se. Alternatively or in addition, at least one hash value may be formed as a function of the at least one portion of the binary code data. It is conceivable, for example, to provide a hash value formation according to the secure hash algorithm (SHA), as it is defined in the Secure Hash Standard (SHS), publication number FITS 180-4, edition August 2015 and retrievable from the Internet, for example, at http://csrc.nist/gov/publications/fips/fips_180-4/fips-180-4.pdf.

Other comparable methods are also conceivable for forming the test data.

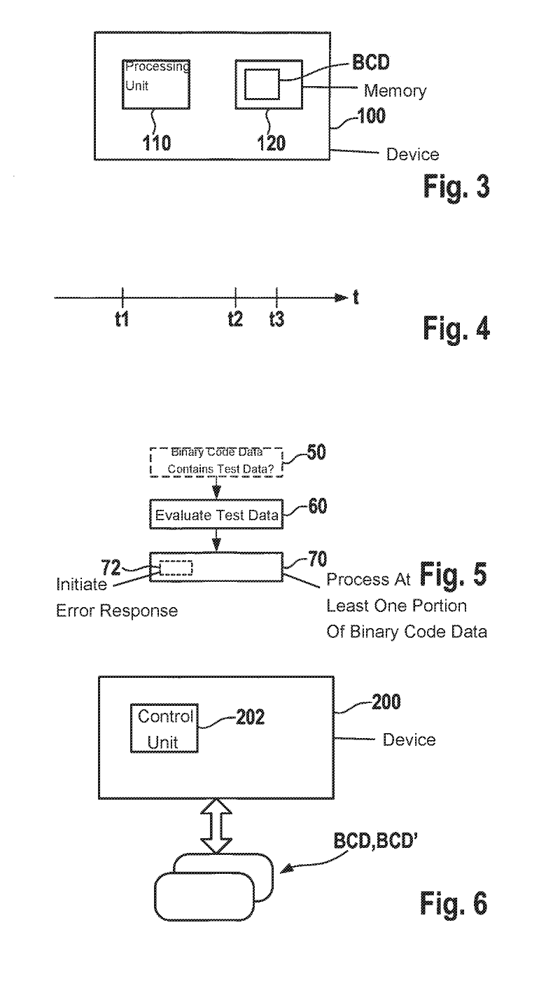

FIG. 3 schematically shows a simplified block diagram of one specific embodiment of a device 100 according to the present invention for processing binary code data BCD containing at least one machine program MP1, MP2. Device 100 is designed to carry out the method according to the present invention described above with reference to FIG. 2 or corresponding variants thereof. For this purpose, device 100 may have a processing unit 110 for executing the method according to the present invention, as well as a memory 120 for at least temporarily storing binary code data BCD to be processed according to the present invention. Binary code data BCD are feedable, for example, as input data to device 100 according to FIG. 1a. Device 100 then executes according to FIG. 2, as a result of which supplemented binary code data BCD′, cf. for example, FIG. 1b, are obtained. These supplemented binary code data BCD′ may then be stored in an electronic or optical or other memory medium (volatile or non-volatile) for a later processing by processing unit 300. Alternatively, supplemented binary code data BCD′ may also be transmitted directly to processing unit 300.

Device 100 may, for example, also be part of a software development environment, in which computer programs for processing unit 300 may be developed, for example, with the aid of a high-level language compiler and of a linker. Once bound by the linker, binary code data BCD according to FIG. 1a, for example, are present and the method (FIG. 2) according to the present invention may then be applied. Processing unit 110 may also be part of a personal computer, for example.

The aspect of generating and embedding test data PD (FIG. 1b, 2) according to the present invention may also be referred to as static binary code data transformation from input state BCD (FIG. 1a) to output state BCD′ (FIG. 1b) or BCD″ (FIG. 1c). The test data according to one preferred specific embodiment are preferably formed and added on a cache line basis (i.e. in each case binary code data blocks having the length of a cache line). The static binary code transformation produces a discernible increase in the data volume at least by test data PD, whereas an execution of embedded programs MP1, MP2 generally unaffected by the test data is possible.

A second aspect of the present invention, which may also be referred to as a dynamic aspect compared to the aforementioned static binary code transformation, is specified by the method for processing binary code data BCD, BCD′ containing at least one machine program MP1, MP2 described by way of example below with reference to the flow chart of FIG. 5 and the time diagram of FIG. 4. This method aspect is characterized by the following steps: evaluating 60 test data PD contained at least partially in (supplemented) binary code data BCD′ (FIG. 1b), which were formed as a function of at least one portion of binary code data BCD at a first point in time t1 (FIG. 4) (for example, by device 100 according to FIG. 3 and by the method according to FIG. 2), evaluation 60 of test data PD involving, in particular, the determination of whether the at least one portion of binary code data BCD′, BCD″ at point in time t2>t1 (FIG. 4) of evaluation 60 is changed relative to first point in time t1, processing 70 (FIG. 5) at least one portion of binary code data BCD′, BCD″ as a function of evaluation 60.

In one preferred specific embodiment, it is provided that processing 70 (FIG. 5) of at least one portion of binary code data BCD, BCD′ takes place independently of evaluation 60. This enables, for example, a time-delayed evaluation and a more rapid processing of the data.

In one preferred specific embodiment, it is provided that it is initially ascertained 50 prior to the evaluation 60 whether binary code data BCD, BCD′, BCD″ contain test data PD.

In one preferred specific embodiment, it is provided that an error response is initiated 72 (FIG. 5) if evaluation 60 indicates that the at least one portion of binary code data BCD′, BCD″ at point in time t2 (FIG. 4) of evaluation 60 is changed relative to first point in time t1. This may take place, for example, at point in time t3>t2 according to FIG. 4.

According to one specific embodiment, an error response in the form of an interrupt request (IRQ) may be sent to a processing unit 300 (FIG. 7), which processes the binary code data, or is intended to execute the machine programs contained therein. Alternatively or in addition to the interrupt request, an entry in an error memory (non-volatile memory or also register of processing unit or the like) may take place. The signaling of the error to an error handling logic is also conceivable.

In one preferred specific embodiment, it is provided that test data PD contained in binary code data BCD′, BCD″ (FIG. 1b, 1c) are replaced by machine instructions executable by processing unit 300 prior to an execution of the at least one machine program MP1, MP2 by a processing unit 300, the machine instructions preferably including one or multiple zero operations (for example, NOP). The replacement described above may take place in step 70 or before or after step 70.

FIG. 6 schematically shows a block diagram of one specific embodiment of a device 200 according to the present invention for carrying out the method described above with reference to FIG. 5. Device 200 includes for this purpose a processing and control unit 202, in which the method according to FIG. 5 is executable. As schematically represented by the block arrow in FIG. 6, device 200 is able to access or to read and/or to write binary code data BCD, respectively, supplement binary code data BCD′ (respectively BCD″, cf. also FIG. 1c) according to the present invention. For example, device 200 may obtain supplemented binary code data BCD′ as input data, thereafter apply the method according to FIG. 5 and store binary code data obtained therefrom (in which previously existing test data PD, for example, were replaced by zero operations) or to provide the binary code data to processing unit 300.

Device 200 (FIG. 7) is particularly preferably assigned to or integrated into processing unit 300.

In one preferred specific embodiment, device 200 is integrated into processing unit 300 in such a way that it is situated in a memory access path between processor core 302 and, for example, a processor (instruction) cache (not shown) and an (external) memory 320, or may operate therein within the meaning of the method according to the present invention.

Device 200 according to the present invention is particularly preferably at least partially, preferably however completely designed as hardware circuitry, as a result of which a particularly efficient execution of the method according to the present invention is possible. Device 200 may also be referred to as a “hardware test unit”.

In principle, the hardware test unit according to other invention variants may also be used in a memory access path to an internal (“on-chip”) memory of processing unit 300 (FIG. 7).

In providing a device 200 according to the present invention in the area of or in a processing unit 300, the provision of conventional protective measures for processing unit 300 prior to changes of binary code such as, for example, the use of ECC memories, may be advantageously dispensed with. Compared to the conventional hardware-based approaches such as, for example, the provision of ECC memories, the principle according to the present invention offers the particular advantage that also only portions of considered binary code data BCD such as, for example, individual machine programs MP1, MP2 or corresponding data areas DB (FIG. 1a) or even only portions of these pieces of information may be selectively protected. Using the principle according to the present invention, it is conceivable, for example, to secure a particular block B (FIG. 1c) of a machine program MP1 of interest with the test data PD according to the present invention, whereas the remaining binary code data are not secured according to the present invention.

A further advantage of the principle according to the present invention is that it is also applicable if binary code data, which include executable program code or machine programs, are executed from external or internal flash memories. This, too, yields the advantages according to the present invention already cited above.

Although CRC methods and hash value methods were cited above as examples for forming test data PD, generally any type of (preferably) static transformation of binary code data BCD or portions thereof may be used according to other specific embodiments in order to form test data PD. The particular preference in this case is again to operate at the block level with data blocks B (FIG. 1c) in the range of the size of a cache line of the executing processor architecture (cf. processing unit 300). A corresponding “back-transformation”, (FIG. 5, in particular, exchange of test data PD by zero operations), may take place as already described above.

If device 200 is designed to recognize whether a data block B or a cache line or, in general, binary code data BCD′ provided according to the present invention even contain test data PD, it is also possible to transparently execute unmodified code (i.e., binary code, which was not provided with test data PD according to the present invention), without having to switch off device 200.

If, in turn, test data PD are detected by device 200 in supplemented binary code data BCD′ at a given future point in time, an evaluation according to the present invention (step 60 of FIG. 5) may, in turn, take place.

If device 200 according to the present invention is positioned upstream from an instruction cache of processing unit 300, there is the option of checking only cache lines that have instructions. If there is a divided data/code cache or if device 200 is in a memory access path upstream from a split between code and data cache, it may be provided that in the case of data cache lines (i.e., if the corresponding cache memory contains payload data and the like, but no machine instructions) device 200 does not trigger a false alarm, thus, does not initiate any error response due to the absence of test data PD.

In another advantageous specific embodiment, it is possible to recognize data accesses of the processing unit or of processor core 302 instead of code accesses, for example, via pieces of information at a bus that connects the memories to the processor core or at a transport medium (for example, bus master ID, address add-on and the like).

The method according to the present invention particularly preferably enables safeguarding of binary code, i.e. of machine programs in binary code form. Alternatively or in addition, comparable safeguarding of constant data and other data is also conceivable, which may be stored or contained in binary code data BCD described above.

The application of the principle according to the present invention particularly advantageously enables a recognition of changes of binary code, in particular, in an external RAM, but also in a local RAM, of a processing unit, this recognition in particular, being transparent for the processor core and/or for a memory controller of the processing unit and/or for memory modules and/or for an application software.

The principle according to the present invention enables safeguarding of a desired binary code integrity advantageously directly in a memory access path, because device 200 may, for example, be implemented directly in the memory access path. The provided method, as already mentioned, is advantageously transparent for memory, controller, cache and processor and, in particular, unsecured memory modules per se may be used, since safeguarding according to the principle according to the present invention is carried out by device 200. Thus, relatively cost-intensive ECC memory elements may be particularly advantageously dispensed with which, in addition, are not available for all required operating environments.

As also already mentioned above, test data PD formed according to the present invention may be particularly advantageously integrated into binary code data BCD at a compile time (i.e. during a compilation of a computer program with the aim of creating the binary code data), in order to obtain supplemented binary code data BCD′, BCD″. Device 200 according to the present invention, which is integrated preferably directly into a memory path of a processing unit 300, virtually enables an automatic check of the binary code and of test data PD embedded therein. Test data PD may also be embedded in one variant with the aid of a conventional linker, which connects multiple binary code modules to form a program present in binary code form.

The principle according to the present invention is particularly preferably applied on the basis of whole cache lines, resulting in significant savings in memory and memory bandwidth compared to conventional ECC methods.

According to another specific embodiment, the principle according to the present invention may particularly advantageously also be selectively applied to parts of the binary code data to be secured, for example, to individual machine programs MP1, MP2, as well as to individual areas or portions thereof.

In another advantageous specific embodiment, it is provided that device 200 is activated or deactivated by software or, in general, that an operation of device 200 is controlled with the aid of software, which runs on processing unit 300 or on processor core 302. A control is conceivable, for example, as a function of a system state of processing unit 300, and/or as a function of a code criticality (the code criticality defines, for example, whether a relevant machine program MP1 is to be safeguarded in a particular manner by test data PD according to the present invention, or whether—if necessary also as a function of additional criteria such as, for example, operating variables of processing unit 300—safeguarding according to the present invention may be—at least partially—dispensed with), and/or of functions or software modules, etc.

It is further conceivable that in another specific embodiment, device 200 is configurably controllable, in particular, configurably activatable, preferably as a function of an operating mode of processing unit 300 or of a processor core 302 (super user, user . . . ), or as a function of an address area, for example, similar to an MPU (memory protection unit).

Device 200 particularly preferably has, in general, several cycles of time for carrying out the method according to the present invention and does not have to prevent a direct access, for example, as does a conventional MPU.

In another advantageous specific embodiment, it is provided that an early triggering of a next fetch operation (downloading of instructions) is executed, with which the next cache line is fetched from the working memory, for example, from an external DDR RAM. A reduction of the cache miss rate is thereby in particular, advantageously achievable.

Device 200 according to the present invention is particularly advantageously integratable into a functional chain of the following type: processor—instruction cache—bus—memory controller—external DDR memory.

The principle according to the present invention may be particularly advantageously used in all processing units that are provided for processing safety-relevant or otherwise critical tasks, in particular in the area of driver assistance systems, of video monitoring and of autonomous driving.

1.-13. (canceled)

14. A method for processing binary code data containing at least one machine program, comprising:
evaluating test data at least partially contained in the binary code data, the test data being formed at a first point in time as a function of at least one portion of the binary code data, the evaluating including determining whether the at least one portion of the binary code data at a second point in time of the evaluating is changed relative to the first point in time; and
processing at least one portion of the binary code data as a function of the evaluating, wherein the test data contained in the binary code data is replaced by machine instructions executable by the processing unit prior to an execution of the at least one machine program by a processing unit.

15. The method as recited in claim 14, wherein prior to the evaluating, the method comprises ascertaining whether the binary code data contains the test data.

16. The method as recited in claim 14, further comprising:
initiating an error response if the evaluating indicates that the at least one portion of the binary code data at the second point in time of the evaluating is changed relative to the first point in time.

17. The method as recited in claim 14, wherein the machine instructions includes at least one zero operation.

18. A device for processing binary code data containing at least one machine program, comprising:
an arrangement for evaluating test data at least partially contained in the binary code data, the test data being formed at a first point in time as a function of at least one portion of the binary code data, the evaluating including determining whether the at least one portion of the binary code data at a second point in time of the evaluating is changed relative to the first point in time; and
an arrangement for processing at least one portion of the binary code data as a function of the evaluating, wherein the test data contained in the binary code data is replaced by machine instructions executable by the processing unit prior to an execution of the at least one machine program by a processing unit.

19. A processing unit, comprising:
at least one processor core for executing machine programs, wherein the processing unit is assigned at least one device for processing binary code data containing at least one machine program, the device including:
an arrangement for evaluating test data at least partially contained in the binary code data, the test data being formed at a first point in time as a function of at least one portion of the binary code data, the evaluating including determining whether the at least one portion of the binary code data at a second point in time of the evaluating is changed relative to the first point in time; and
an arrangement for processing at least one portion of the binary code data as a function of the evaluating, wherein the test data contained in the binary code data is replaced by machine instructions executable by the processing unit prior to an execution of the at least one machine program by a processing unit.

20. The processing unit as recited in claim 19, wherein the at least one device is integrated into the processing unit.

21. The processing unit as recited in claim 19, wherein the processing unit is a microcontroller.

22. A control unit for a vehicle, comprising:
one of at least one device and at least one processing unit associated with at least processor core, the one of the at least one device and the at least one processing unit being for processing binary code data containing at least one machine program and including:
an arrangement for evaluating test data at least partially contained in the binary code data, the test data being formed at a first point in time as a function of at least one portion of the binary code data, the evaluating including determining whether the at least one portion of the binary code data at a second point in time of the evaluating is changed relative to the first point in time; and
an arrangement for processing at least one portion of the binary code data as a function of the evaluating, wherein the test data contained in the binary code data is replaced by machine instructions executable by the processing unit prior to an execution of the at least one machine program by a processing unit.

23. The control unit as recited in claim 22, wherein the vehicle includes a motor vehicle.
